(19) United States
(12) Patent Application Publication
(10) Pub. No.: US 2025/0300201 A1
(43) Pub. Date: Sep. 25, 2025

(54) Anode Side Integrated Flow Channel Module and Anode Subsystem for Dual-Stack Fuel Cell System

(71) Applicants: Robert Bosch GmbH, Stuttgart (DE); Bosch Hydrogen Powertrain Systems (Chongqing) Co., Ltd., Chongping (CN)

(72) Inventors: Baotong Wang, Chongqing (CN); Fengming Dai, Chongqing (CN)

(21) Appl. No.: 19/083,009

(22) Filed: Mar. 18, 2025

(30) Foreign Application Priority Data
Mar. 22, 2024 (CN) 2024 2056 5665.6

(51) Int. Cl. H01M 8/04082; H01M 8/04089; H01M 8/2465

(52) U.S. Cl. CPC H01M 8/04201; H01M 8/04097; H01M 8/2465

(57) ABSTRACT

An integrated flow channel module of an anode subsystem for a dual-stack fuel cell system includes (i) a first side surface configured to be sealed and connected to an end cover of a stack, (ii) multiple groups of channels recessed from the first side surface along the thickness direction of the integrated flow channel module, the multiple groups of channels being configured to be fluidically connected to a first and second ejector of the anode subsystem and a water separation recycling pump to form a first flow path for recycling the fuel discharged from anode outlets of a first and second stack back to anode inlets of the first and second stacks, and (iii) a group of distribution channels formed inside the integrated flow channel module, the group of distribution channels being configured to fluidically connect a fuel source of the anode subsystem to the first and second ejectors to form a second flow path for distributing the fuel from the fuel source between the first and second ejectors. An anode subsystem for a dual-stack fuel cell system including the integrated flow channel module is also disclosed.

This application claims priority under 35 U.S.C. § 119 to application no. CN 2024 2056 5665.6, filed on Mar. 22, 2024 in China, the disclosure of which is incorporated herein by reference in its entirety.

The present application generally relates to the field of fuel cell technology, and more specifically to an integrated flow channel module for an anode side of a dual-stack fuel cell system and an anode subsystem for a dual-stack fuel cell system having the integrated flow channel module.

### BACKGROUND

Fuel cells represent a power generation technology that is gaining widespread adoption. They utilize the electrochemical reaction between fuel and oxidant to convert the chemical energy of the fuel directly into electrical energy. In comparison to traditional combustion power generation methods, fuel cells offer several advantages, including high conversion efficiency, low pollutant emissions, and quiet, reliable operation.

The dual-stack single system mode represents a promising development direction for fuel cell systems aimed at achieving higher power and greater integration. In this dual-stack single system mode, two fuel cell stacks (hereinafter referred to as “stacks”) are arranged side by side and connected in parallel to create a fuel cell “dual stack”. A single fuel supply system is employed to provide fuel to both stacks, which is also referred to as a “single system”. For the fuel cell dual stack, the physical and chemical properties (such as flow, pressure, fuel concentration, temperature, etc.) of the fuel distributed to each stack via the single fuel supply system must be roughly consistent. This consistency ensures that both stacks operate under similar fuel input conditions, leading to comparable electrical output. By minimizing the compensation current between the dual stack, this arrangement promotes efficient and stable operation.

In addition to fuel distribution, the anode side subsystem of the dual-stack fuel cell system also involves the recovery and recycling of fuel. Typically, excess fuel is supplied to the stack to ensure that the electrochemical reaction is fully completed. The unreacted or unused fuel is then recycled back to the anode inlet of the stack by a recycling pump for reuse.

In order to realize the distribution and recycling of fluid (i.e., fuel flow) required on the anode side of the dual-stack fuel cell system, in the prior art, multiple groups of dispersed three-way rigid pipes are generally used for flow diversion and confluence. Together with the multiple groups of dispersed three-way rigid pipes, brackets are used to provide stable support for the rigid pipes, and different ferrule connectors are used to achieve port docking between the rigid pipes and functional components. However, the use of these brackets and ferrule connectors results in a bulky anode subsystem, complicates manufacturing and mounting processes, and leads to cramped spatial conditions.

Therefore, there is a need for an improved flow channel arrangement structure on the anode side that addresses the issues present in the prior art.

### SUMMARY

The present application provides a new integrated flow channel concept designed for the anode subsystem for a dual-stack fuel cell system. This integrated flow channel concept fundamentally contrasts with traditional design approaches, which determine the mounting positions of fluidic connection pipelines based on the locations of dispersed functional components. Instead, it facilitates the necessary fluidic connections between the system's functional components through an integrated structure, providing mounting fixing points for those components. As a result, the functional components of the anode subsystem can be closely arranged and compactly assembled based on the integrated flow channel. This arrangement reduces the overall volume occupied by the anode subsystem and streamlines the overall process of fuel supply and recycling, thereby enhancing the uniformity and reliability of fluid distribution. By minimizing the use of accessories such as brackets and ferrule connectors, the integrated flow channel according to the present disclosure also not only lowers production costs for the dual-stack fuel cell system but also simplifies the mounting process of the anode subsystem.

According to one aspect of the present application, an integrated flow channel module of an anode subsystem for a dual-stack fuel cell system is provided, characterized in that it comprises: a first side surface configured to be sealed and connected to an end cover of a stack; multiple groups of channels recessed from the first side surface along the thickness direction of the integrated flow channel module, the multiple groups of channels being configured to be fluidically connected to a first and second ejector of the anode subsystem and a water separation recycling pump to form a first flow path for recycling the fuel discharged from anode outlets of a first and second stack back to anode inlets of the first and second stacks; and a group of distribution channels formed inside the integrated flow channel module, the group of distribution channels being configured to fluidically connect a fuel source of the anode subsystem to the first and second ejectors to form a second flow path for distributing the fuel from the fuel source between the first and second ejectors.

Optionally, a first group of interfaces configured to be connected to the anode outlets of the first and second stacks, a second group of interfaces configured to be connected to the water separation recycling pump, a third group of interfaces configured to be connected to the first and second ejectors, and a fourth group of interfaces configured to be connected to the anode inlets of the first and second stacks of the integrated flow channel module, are arranged sequentially along the width direction of the integrated flow channel module.

Optionally, along the length direction of the integrated flow channel module: the first group of interfaces are arranged in the second group of interfaces between a first and second pump interface respectively configured to be connected to an input port and an output port of the water separation recycling pump, and the third group of interfaces extends from a position roughly flush with the first pump interface to a greater length range than the second group of interfaces.

Optionally, along the length direction of the integrated flow channel module, in the third group of interfaces, the first and third group of interfaces configured to be connected to the first ejector and the second and the third group of interfaces configured to be connected to the second ejector are arranged separately and/or substantially aligned along the length direction of the integrated flow channel module.

Optionally, the multiple groups of channels comprise a first group of channels fluidically connecting a first group of interfaces to a first pump interface, wherein a first anode outlet interface in the first group of interfaces is farther from the first pump interface than a second anode outlet interface in the first group of interfaces, and wherein a first converging branch channel in the first group of channels, which is configured to fluidically connect the first anode outlet interface to the first pump interface, has a section of the channel extending between the first and second anode outlet interfaces along the length direction of the integrated flow channel module.

Optionally, the multiple groups of channels comprise a second group of channels configured to fluidically connect the water separation recycling pump to the first and second ejectors, wherein the second group of channels comprises a first recycling branch channel fluidically connecting the second pump interface to a first ejection interface in the third group of interfaces, which is configured to be connected to an ejection inlet of the first ejector, and a second recycling branch channel fluidically connecting the second pump interface to a second ejection interface in the third group of interfaces, which is configured to be connected to an ejection inlet of the second ejector, wherein the second pump interface is unequally distant from the first and second ejection interfaces, and wherein the first and second recycling branch channels have different flow channel configurations configured to allow the fluidic flow to have substantially consistent flow and pressure at the first and second ejection interfaces.

Optionally, the multiple groups of channels comprise a third group of channels configured to fluidically connect the first and second ejectors to the anode inlets of the first and second stacks respectively, wherein the third group of channels comprises a first feed channel that fluidically connects a first mixing outlet interface in the third group of interfaces, which is configured to be connected to a jet-ejection mixing outlet of the first ejector, to a first anode inlet interface in the fourth group of interfaces, which is configured to be connected to the anode inlet of the first stack, and a second feed channel that fluidically connects a second mixing outlet interface in the third group of interfaces, which is configured to be connected to a jet-ejection mixing outlet of the second ejector, to a second anode inlet interface in the fourth group of interfaces, which is configured to be connected to the anode inlet of the second stack, wherein the distance between the first mixing outlet interface and the first anode inlet interface is different from the distance between the second mixing outlet interface and the second anode inlet interface, and wherein the first and second feed channels have different flow channel configurations configured to allow the fluidic flow to have substantially consistent flow and pressure at the first and second anode inlet interfaces.

Optionally, the group of distribution channels is fluidically connected to a source interface of the integrated flow channel module, which is configured to be connected to a fuel source, and the group of distribution channels comprises a source fuel main branch channel fluidically connected to the source interface, a first source fuel branch channel branching from the source fuel main branch channel and fluidically connected to a first jet interface in the third group of interfaces, which is configured to be connected to the jet inlet of the first ejector, and a second source fuel branch channel branching from the source fuel main branch channel and fluidically connected to a second jet interface in the third group of interfaces, which is configured to be connected to the jet inlet of the second ejector, wherein the first and second source fuel branch channels have substantially the same flow.

Optionally, the group of distribution channels has a substantially constant flow area, and/or the group of distribution channels has a smaller flow area than the multiple groups of channels, and/or a purge flow channel structure for introducing a working medium into a purge port of an end cover of a stack is also formed in the integrated flow channel module.

According to another aspect of the present application, an anode subsystem for a dual-stack fuel cell system is provided, the dual-stack fuel cell system comprising a first and second stack arranged in a stack and connected in parallel, and the anode subsystem being characterized in that it comprises a fuel source, a first ejector, a second ejector, a water separation recycling pump and the above-mentioned integrated flow channel module, wherein the integrated flow channel module is fluidically connected to the fuel source, the first ejector, the second ejector and the water separation recycling pump to form a distribution flow path for providing fuel from the fuel source to anode inlets of the first and second stacks via the first and second ejectors, respectively, and a recycling flow path for recycling the fuel discharged from anode outlets of the first and second stacks back to the anode inlets of the first and second stacks via the first and second ejectors, respectively.

### BRIEF DESCRIPTION OF THE DRAWINGS

The following is an explanation of the examples according to the principles of the present application in conjunction with the accompanying drawings. The accompanying drawings are provided to make the disclosure of the present application complete and sufficient, and to convey the concept of the present application to those skilled in the art in an intuitive manner. However, the accompanying drawings are only provided as examples and are not intended to be limiting. Without departing from the spirit and scope of the present disclosure, those skilled in the art may adjust, modify and/or replace the specific implementations of the features illustrated in the accompanying drawings as appropriate.

FIG. 1 is a schematic block diagram of an anode subsystem for a dual-stack fuel cell system according to the principles of the present application, illustrating the basic components of the anode subsystem and the corresponding fluidic connection relationship.

FIG. 2A-2D are a series of views of an integrated flow channel module for the anode subsystem shown in FIG. 1 according to the principles of the present application, wherein FIG. 2A is a stereoscopic view of the integrated flow channel module observed from the side of the integrated flow channel module facing an end cover of a stack, FIG. 2B is a plan view of the integrated flow channel module observed from the side of the integrated flow channel module away from an end cover of a stack, FIG. 2C is a sectional stereoscopic view of the integrated flow channel module cut along the line A-A in FIG. 2B, and FIG. 2D is a sectional stereoscopic view of the integrated flow channel module cut by a plane perpendicular to the lateral direction (also referred to as the thickness direction of the integrated flow channel module), illustrating the flow channel formed inside the integrated flow channel module.

### DETAILED DESCRIPTION

Although the following description primarily focuses on a dual-stack fuel cell system with parallel-connected stacks, the integrated flow channel module according to the principles of the present application is not limited thereto. As is easily understood by those skilled in the art, the integrated flow channel module concept disclosed in the present application can also be applied to other multi-stack fuel cell systems. After reviewing the present disclosure, those skilled in the art will be capable of making appropriate modifications, substitutions and/or adjustments to specific situations. The inventors also intend that the principles disclosed herein be practiced in ways that differ from those specifically described herein.

For ease of description, terms such as “fluidic connection” and “fluidic communication” are used herein to indicate that an element or feature forms a flow path with another element or feature, allowing fluid to flow from the one element or feature to the another element or feature or from the another element or feature to the one element or feature, either directly (e.g., through contact or docking) or indirectly (e.g., via intermediate elements or features such as channels, pipelines, chambers, etc.).

The use of terms such as “first”, “second”, “third”, “fourth” and the like is intended to distinguish one feature or element from another feature or element, and does not imply the quantity and/or arrangement relationship of the features or elements. In addition, the length direction of the integrated flow channel module is also referred to as the longitudinal direction, the width direction of the integrated flow channel module is also referred to as the transverse direction, and the thickness direction of the integrated flow channel module is also referred to as the lateral direction.

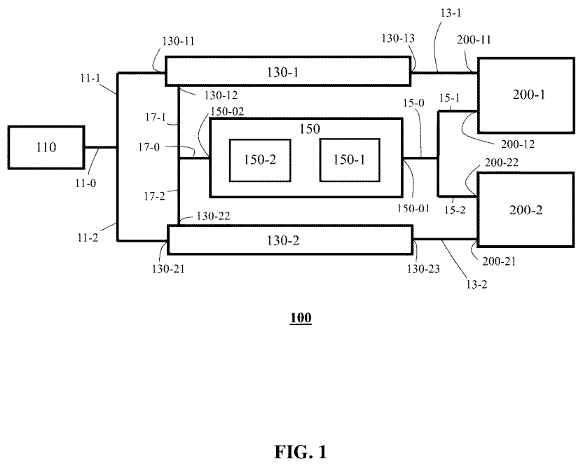

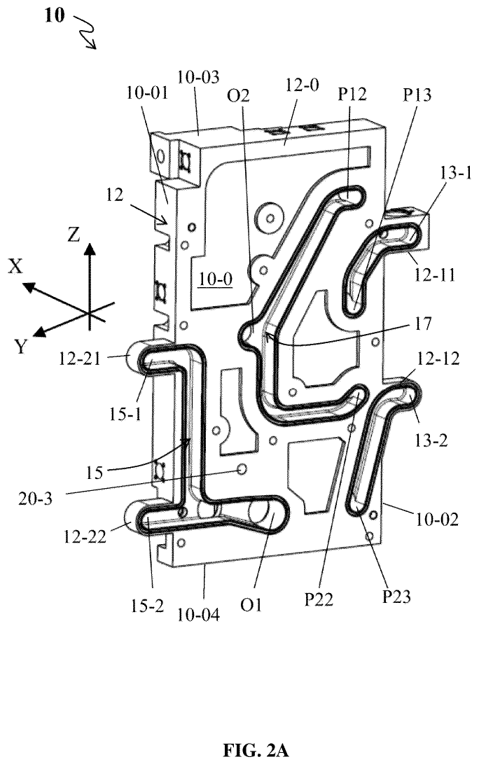

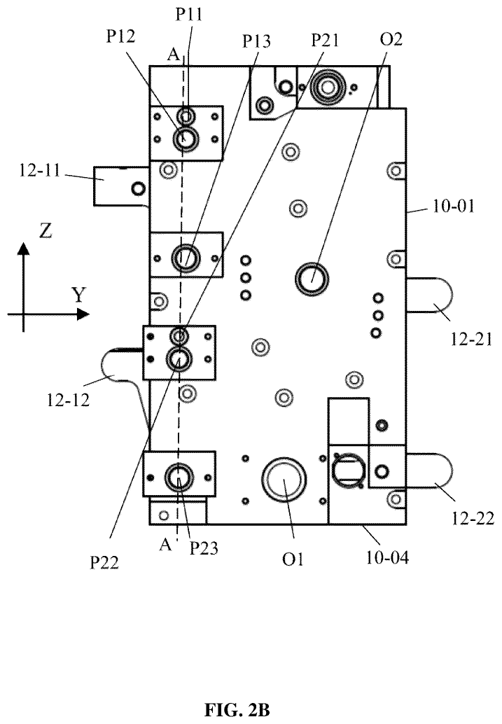

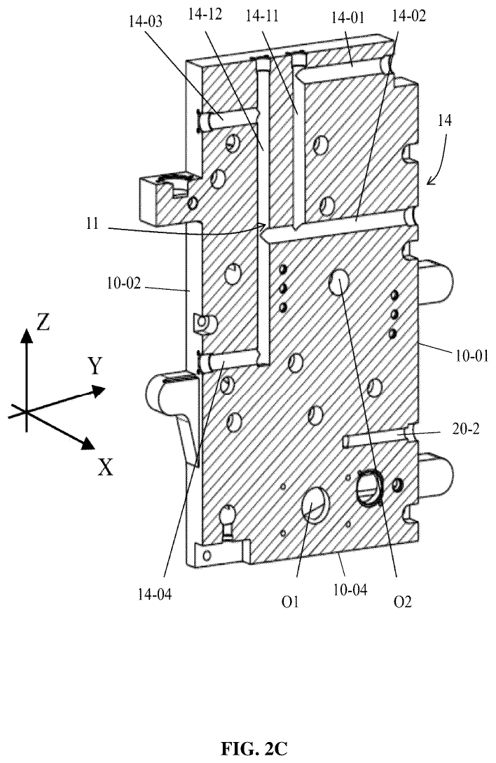

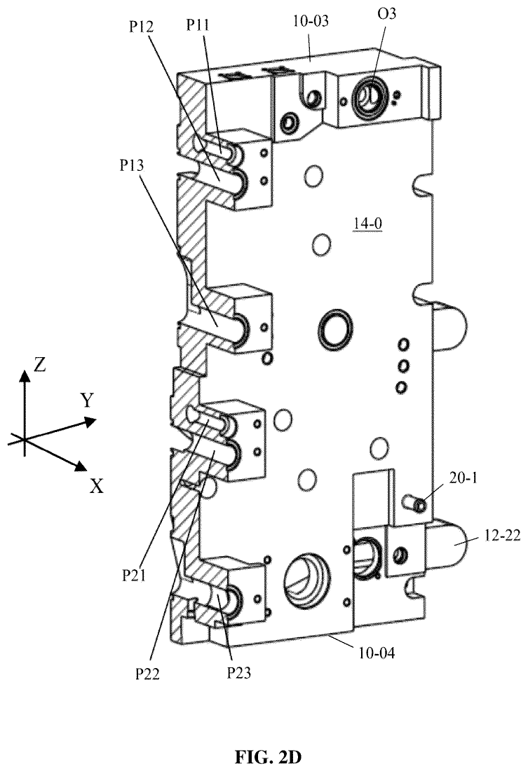

FIG. 1 is a schematic block diagram of a fuel supply system 100 for a dual-stack fuel cell according to the principles of the present application. As shown in FIG. 1, the fuel supply system 100 comprises a fuel source 110, a first ejector 130-1 fluidically connected between the fuel source 110 and an anode inlet 200-11 of a first stack 200-1 of the dual-stack fuel cell system, a second ejector 130-2 fluidically connected between the fuel source 110 and an anode inlet 200-21 of a second stack 200-2 of the dual-stack fuel cell system, a water separation recycling pump 150 fluidically connected between an anode outlet 200-12 of the first stack 200-1 and a recycling fuel inlet 130-12 of the first ejector 130-1 and fluidically connected between an anode outlet 200-22 of the second stack 200-2 and a recycling fuel inlet 130-22 of the second ejector 130-2, and an integrated flow channel module 10 (see FIG. 2A) configured to provide appropriate fluidic connections between the aforementioned components.

The fuel source 110 is configured as a source of an anode reactant (also referred to as “fuel”) for an electrochemical reaction. The fuel source 110 may be a reservoir storing the anode reactant, or may be another chemical generator capable of producing the anode reactant. For example, in a hydrogen fuel cell, the reservoir may be a hydrogen storage tank storing either gaseous hydrogen or liquid hydrogen, or the chemical generator may be an electrolyzer configured to electrolyze water and produce hydrogen. However, the present disclosure is not limited thereto. It also encompasses other forms of fuel sources capable of providing anode reactants to stacks.

The fuel source 110 is fluidically connected to both the first ejector 130-1 and the second ejector 130-2 via a source fuel flow channel structure 11 (see FIG. 2C) of the integrated flow channel module 10, so as to provide high-pressure fresh fuel to the first stack 200-1 and the second stack 200-2 via the first ejector 130-1 and the second ejector 130-2, respectively. Accordingly, the source fuel flow channel structure 11 is configured to separate the fuel flow from the fuel source 110 into two branch fuel flows, and has a source fuel main branch flow channel 11-0 configured to be connected to a fuel supply port of the fuel source 110, a source fuel first branch flow channel 11-1 branched from the source fuel main branch flow channel 11-0 and connected to an jet inlet 130-11 of the first ejector 130-1, and a source fuel second branch flow channel 11-2 branched from the source fuel main branch flow channel 11-0 and connected to an jet inlet 130-21 of the second ejector 130-2.

The first ejector 130-1 and the second ejector 130-2 mix the high-pressure fresh fuel received from the fuel source 110 via the source fuel flow channel structure 11 of the integrated flow channel module 10 with the recycled low-pressure fuel, and feed the mixed fuel to the anode inlets 200-11 and 200-21 of the stacks through the corresponding jet-ejection mixing outlets 130-13 and 130-23. According to one example, the first ejector 130-1 and the second ejector 130-2 may each have a venturi configuration to facilitate sufficient mixing of the high-pressure fresh fuel and the recycled low-pressure fuel before feeding to the stacks. Preferably, the first ejector and the second ejector have substantially the same configuration to facilitate the fuel flow properties provided to the anode inlets of each stack to remain substantially consistent.

The fuel flow exiting from the jet-ejection mixing outlet 130-13 of the first ejector 130-1 is fed to the anode inlet 200-11 of the first stack 200-1 through a first fuel feed flow channel 13-1, where the fuel flow undergoes an electrochemical reaction in the first stack 200-1 to achieve energy conversion. Similarly, the fuel flow exiting from the jet-ejection mixing outlet 130-23 of the second ejector 130-2 is fed to the anode inlet 200-21 of the second stack 200-2 through the second fuel feed flow channel 13-2, where the fuel flow undergoes an electrochemical reaction in the second stack 200-2 to achieve energy conversion. Since excess fuel is supplied to ensure that the electrochemical reaction in the stacks 200-1 and 200-2 proceeds fully, some of the fed fuel remains unconsumed. This unconsumed fuel, along with a small amount of water, is discharged from the anode outlet 200-12 of the first stack 200-1 and the anode outlet 200-22 of the second stack 200-2. It is then collected through a recycling converging flow channel structure 15 (see FIG. 2A) of the integrated flow channel module 10 and directed to the water separation recycling pump 150. Accordingly, the recycling converging flow channel structure 15 is configured to transport the fluid (primarily in gaseous form but containing some droplets) from the anode outlet of each stack to the water separation recycling pump 150 in a centralized manner, and may comprise a first recycling converging branch 15-1 configured to be connected to the anode outlet 200-12 of the first stack 200-1, a second recycling converging branch 15-2 configured to be connected to the anode outlet 200-22 of the second stack 200-2, and a recycling converging main branch 15-0 that connects the first and second recycling converging branches to an input port 150-01 of the water separation recycling pump 150.

The water separation recycling pump 150 comprises a water separation module 150-1 for providing a water separation function, and a booster module 150-2 fluidically connected to the water separation module for pressurizing the recycled fuel. The water separation module 150-1, for example, may be configured to separate the lighter fuel gas from the heavier droplets by way of centrifugal force and gravity. The booster module 150-2, for example, may be configured to boost the gas flow by way of compressing gas. Although the water separation recycling pump 150 is decomposed into the water separation module 150-1 and the booster module 150-2 for functional clarity, it should be understood that this does not intend to imply that the water separation module 150-1 and the booster module 150-2 are necessarily separate components. On the contrary, as those skilled in the art will readily understand, the booster module 150-2 may also be integrated with the water separation module 150-1. In this configuration, the centrifugal rotation of the inflowing fluidic flow by virtue of the booster module allows for the separation of droplets in the fluidic flow from the fuel gas in directions other than gravity.

The fluidic flow that has undergone water separation and pressurization by the water separation recycling pump 150 (hereinafter also referred to as the “recycling fuel flow”) is transmitted from an output port 150-02 of the water separation recycling pump 150 and is delivered to the ejection inlets 130-12 and 130-22 of the first and second ejectors via a recycling distribution channel structure 17 (see FIG. 2A). Accordingly, the recycling distribution channel structure 17 is configured to distribute the recycled fuel flow from the water separation recycling pump 150 between the first ejector 130-1 and the second ejector 130-2, and may comprise a recycling distribution main branch flow channel 17-0 connected to the output port 150-02 of the water separation recycling pump 150, a first recycling distribution branch flow channel 17-1 branched from the recycling distribution main branch flow channel 17-0 and connected to the ejection inlet 130-12 of the first ejector 130-1, and a second recycling distribution branch flow channel 17-2 branched from the recycling distribution main branch flow channel 17-0 and connected to the ejection inlet 130-22 of the second ejector 130-2.

As has been explained above, the fluidic connections for providing fuel from the fuel source 110 to the anode inlets of the stacks and recycling the fuel from the anode outlets of the stacks back to the anode inlets of the stacks is provided in the form of the integrated flow channel module 10 according to the principles of the present disclosure. The integrated flow channel module 10 is configured to realize the corresponding fluidic connections of the anode side functional components of the dual-stack fuel cell system and provide mounting fixing points for functional components such as ejectors and water separation recycling pump, thereby allowing the functional components to be closely arranged along the integrated flow channel module 10. This promotes the overall structural strength and anti-seismic performance of the anode side.

Structural details of an example of the integrated flow channel module 10 according to the principles of the present application are illustrated in FIGS. 2A-2D.

Reference is first made to FIG. 2A which best illustrates a first side portion 12 of the integrated flow channel module 10, which is configured to connect an end cover of a stack. Specifically, the first side portion 12 comprises a first side surface 12-0 configured to dock with the end cover of the stack, wherein the first side surface is sealed and connected to the end cover of the stack by way of a seal. Preferably, as shown in bold lines in FIG. 2A, the seal is arranged around the periphery of the recycling converging flow channel structure 15, the recycling distribution channel structure 17, and the first fuel feed flow channel 13-1 and the second fuel feed flow channel 13-2 recessed from the first side surface 12-0 along a first lateral direction (i.e., along the direction of the X axis in FIGS. 2A-2D).

In the example of FIGS. 2A-2D, an integrated flow channel structure 10 generally comprises a substantially rectangular body 10-0 defined by a first longitudinal edge 10-01, a second longitudinal edge 10-02, a first transverse edge 10-03, and a second transverse edge 10-04. However, other shapes are also possible. A first anode outlet lug 12-21 and the second anode outlet lug 12-22 protrude from the first longitudinal edge 10-01 of the body 10-0 along the first transverse direction (i.e., along the Y axis direction in FIGS. 2A-2D), respectively, and have a protrusion distance from the first longitudinal edge 10-01, which is configured to cover the anode outlet 200-12 of the first stack 200-1 and the anode outlet 200-22 of the second stack 200-2 in use. A first anode inlet lug 12-11 and a second anode inlet lug 12-12 protrude from the second longitudinal edge 10-02 of the body 10-0 along the second transverse direction opposite to the first transverse direction, respectively, and have a protrusion distance from the second longitudinal edge 10-02, which is configured to cover the anode inlet 200-11 of the first stack 200-1 and the anode inlet 200-21 of the second stack 200-2 in use. When used, the length direction (i.e., the longitudinal direction) of the integrated flow channel module will be oriented parallel to the gravity direction, thus the longitudinal direction is sometimes referred to as the vertical direction, the first transverse edge 10-03 is referred to as the upper transverse edge 10-03, and the second transverse edge 10-04 is referred to as the lower transverse edge 10-04. In the example shown in FIG. 2A, the second anode outlet lug 12-22 is closer to the lower transverse edge 10-04 than the first anode outlet lug 12-21, and the first anode inlet lug 12-11 is closer to the upper transverse edge 10-03 than the second anode inlet lug 12-12. In addition, the longitudinal distance between the first anode inlet lug 12-11 and the first anode outlet lug 12-21, and the longitudinal distance between the second anode inlet lug 12-12 and the second anode outlet lug 12-22 are substantially equal. Thus, as is readily understood by those skilled in the art, the longitudinal dimension (i.e., length) of the body 10-0 of the integrated flow channel module 10 is greater than the vertical distance between the anode inlet of the first stack and the anode outlet of the second stack, and the transverse dimension (i.e., width) of the body 10-0 of the integrated flow channel module 10 is less than the horizontal distance between the anode inlet and the anode outlet of the first or second stack.

The recycling converging flow channel structure 15 is defined in the first anode outlet lug 12-21, the second anode outlet lug 12-22 and the peripheral portion of the body 10-0 adjacent to the first and second anode outlet lugs. The recycling converging flow channel structure 15, as shown in FIG. 2A, generally comprises a channel formed by a laterally extending enclosing side wall and a bottom wall connected to the side wall and recessed relative to the first side surface 12-0, and a recycling converging orifice O1 extending from the bottom wall along the first lateral direction through the body 10-0. Similarly, the recycling distribution channel structure 17 and the first fuel feed flow channel 13-1 and the second fuel feed flow channel 13-2 each generally comprise a channel formed by a laterally extending enclosing side wall and a bottom wall, and an orifice or flow channel opening extending from the bottom wall along the first lateral direction through the body.

In the example of FIG. 2A, the first recycling converging branch flow channel 15-1 of the recycling converging flow channel structure 15 is constructed to have a first transverse flow channel section extending from the free end of the first anode outlet lug 12-21 into the body 10-0 along the second transverse direction, and a second longitudinal flow channel section extending longitudinally along the peripheral portion of the body, which is disposed between the first and second anode outlet lugs in the body 10-0, thereby forming a shape substantially similar to the Arabic numeral “7”. Accordingly, the second recycling converging branch flow channel 15-2 extends from the free end of the second anode outlet lug 12-22 into the body 10-0 along the second transverse direction, and meets the first recycling converging branch flow channel 15-1 at a position of the body 10-0 substantially flush with the second anode outlet lug 12-22 to merge into the recycling converging main branch flow channel 15-0. The recycling converging main branch flow channel 15-0 extends at an angle along the second transverse direction to the recycling converging orifice O1 which is longitudinally lower than the second anode outlet lug and transversely deviates from the first longitudinal edge 10-01 by a third distance, so as to be fluidically connected to the input port 150-01 of the water separation recycling pump 150 which is configured to be mounted on a second side portion 14 (see FIG. 2C) opposite to the first side portion 12 of the integrated flow channel module 10 via the recycling converging orifice O1. The second longitudinal flow channel section of the first recycling converging branch flow channel 15-1 helps initially separate the liquid water and the gaseous fuel in the fluidic flow discharged from the anode outlet of the first stack, and the longitudinal positioning of the recycling converging orifice O1 which is lower than the second anode outlet lug 12-22 further promotes the drainage of the separated liquid water.

Meanwhile, referring to FIG. 2B, a recycling distribution orifice O2 of the recycling distribution channel structure 17 matched with the output port 150-02 of the water separation recycling pump 150 is positioned higher than the first anode outlet lug 12-21 at a fourth distance from the first longitudinal edge 10-01 along the second transverse direction. Thus, along the length direction of the integrated flow channel module 10, the first and second anode outlet lugs are positioned between the orifices O1 and O2. According to the illustration of FIG. 2B, the recycling converging orifice O1 is substantially located in the transverse middle of the body 10-0, and the fourth distance is slightly smaller than the third distance. Thus, the integrated flow channel module 10 is configured to be connected to the water separation recycling pump 150 at a substantially middle position of the body 10-0.

At the same time, as best seen in FIG. 2B, at a position farther from the first longitudinal edge 10-01 of the body 10-0 than the orifice O1 (or in other words, closer to the second longitudinal edge 10-02 of the body 10-0 than the orifice O1), the following are arranged in sequence along a second longitudinal direction toward the lower transverse edge 10-03: a first source fuel flow channel port P11 configured to be connected to the jet inlet 130-11 of the first ejector 130-1, a first recycling distribution flow channel port P12 configured to be connected to the ejection inlet 130-12 of the first ejector 130-1, a first fuel feed flow channel port P13 configured to be connected to the jet-ejection mixing outlet 130-13 of the first ejector 130-1, a second source fuel flow channel port P21 configured to be connected to the jet inlet 130-21 of the second ejector 130-2, a second recycling distribution flow channel port P22 configured to be connected to the ejection inlet 130-22 of the second ejector 130-2, and a second fuel feed flow channel port P23 configured to be connected to the jet-ejection mixing outlet 130-23 of the second ejector 130-2. As such, the integrated flow channel module 10 is configured to be connected to the first and second ejectors at the location of the body 10-0 transversely between the orifices O1 and O2, and the first anode inlet lug 12-11 and the second anode inlet lug 12-12.

Referring to FIG. 2B, the first source fuel flow channel port P11 is disposed adjacent to the first recycling distribution flow channel port P12, and the second source fuel flow channel port P21 is disposed adjacent to the second recycling distribution flow channel port P22. Moreover, with the aid of line A-A in FIG. 2B, it can be seen that the flow channel ports P11, P12, P13, P21, P22, and P23 are generally aligned along the length direction of the integrated flow channel module 10. Furthermore, referring to FIG. 2D, the first and second source fuel flow channel ports, the first and second recycling distribution flow channel ports, and the first and second fuel feed flow channel ports extend laterally through the mounting flange of the body 10-0, which protrudes from the second side surface 14-0 away from the end cover of the stack along the first lateral direction, and the mounting flange can facilitate the assembly of a detection instrument which can be configured, for example, to detect the fluidic flow characteristics at the above-mentioned connection nodes. In addition, the first source fuel flow channel port P11 has a smaller diameter than the first recycling distribution flow channel port P12, and the second source fuel flow channel port P21 has a smaller diameter than the second recycling distribution flow channel port P22. In the example illustrated in FIGS. 2A-2D, with reference to FIG. 2B, the second fuel feed flow channel port is positioned substantially flush longitudinally with the recycling converging orifice O1, and the first recycling distribution flow channel port P12 is farther from the recycling distribution orifice O2 than the second recycling distribution flow channel port P23.

Accordingly, the first recycling distribution branch flow channel 17-1 of the recycling distribution main branch flow channel 17-0, which fluidically connects the recycling distribution orifice O2 to the first recycling distribution flow channel port P12, and the second recycling distribution branch flow channel 17-2, which fluidically connects the recycling distribution orifice O2 to the second recycling distribution flow channel port P22, have different flow channel configurations. Specifically, referring back to FIG. 2A, the first recycling distribution branch flow channel 17-1 extends from the recycling distribution orifice O2 along the second transverse direction and along the first longitudinal direction to the first recycling distribution flow channel port P12 in a generally straight manner, while the second recycling distribution branch flow channel 17-2 extends from the recycling distribution orifice O2 first along the second longitudinal direction and then along the second transverse direction to the second recycling distribution flow channel port P22, with a deflection guide portion of approximately 90°. By utilizing the different configurations and thus different flow resistance coefficients of the first and second recycling distribution branch flow channels, even though the first recycling distribution flow channel port P12 is positioned farther from the recycling distribution orifice O2 than the second recycling distribution flow channel port P22 (as shown in FIG. 2B), the fluidic flows guided to the first and second recycling distribution flow channel ports will still have excellent fluidic uniformity and pressure drop consistency. However, it should be understood that the configurations of the first and second recycling distribution branch flow channels are not limited thereto. Any configuration combination that can keep the flow rate and pressure drop at the first and second recycling distribution flow channel ports within an acceptable degree of difference is considered herein.

Similarly, in the example illustrated in FIGS. 2A-2D, with reference to FIG. 2B, the straight-line distance between the first fuel feed flow channel port P13 and the position of the first anode inlet lug 12-11, which corresponds to the first anode inlet 200-11 (i.e., the position substantially close to the free end of the first anode inlet lug), is smaller than the straight-line distance between the second fuel feed flow channel port P23 and the position of the second anode inlet lug 12-12, which corresponds to the second anode inlet 200-21 (i.e., the position substantially close to the free end of the second anode inlet lug). Accordingly, the first fuel feed flow channel 13-1 is formed in the first side portion 12 in a flow channel configuration having a greater flow resistance coefficient than the second fuel feed flow channel 13-2. For example, as best shown in FIG. 2A, the first fuel feed flow channel 13-1 is formed to have more deflection guides than the second fuel feed flow channel port 13-2.

Referring mainly to FIG. 2C, the source fuel flow channel structure 11 configured to deliver high-pressure fresh fuel from the fuel source 110 to the first ejector 130-1 and the second ejector 130-2 is formed in the second side portion 14 of the body 10-0 opposite to the first side portion 12. Referring in combination to FIG. 2B and FIG. 2D, a source fuel orifice O3 for mating with a fuel supply port of the fuel source 110 is formed near a corner formed by the upper transverse edge 10-03 and the first longitudinal edge 10-01 of the second side portion 14. The source fuel orifice O3 extends laterally to connect to a portion formed in the second side portion 14. Mainly for the purpose of simplifying processing and manufacturing, in the example of the integrated flow channel module shown in FIGS. 2A-2D, the source fuel main branch flow channel 11-0 is created using a first transverse channel 14-01 formed in the second side portion 14, a first longitudinal channel 14-11 connected to the first transverse channel 14-01, and a second transverse channel 14-02 connected to the first longitudinal channel 14-11. Similarly, a first source fuel branch flow channel 11-1 is created by using a first portion of a second longitudinal channel 14-12, which extends toward the first transverse edge 10-03, and a portion of a third transverse channel 14-03 connected between the first portion and the first source fuel flow channel port P11, and a second source fuel branch flow channel 11-2 is created by using a second portion of the second longitudinal channel 14-12, which extends toward the second transverse edge 10-04, and a portion of a fourth transverse channel 14-04 connected between the second portion and the second source fuel flow channel port P21. However, the present disclosure is not limited to this. More specifically, any feasible flow channel configuration that allows the source fuel orifice O3 to be fluidically connected to the first and second source fuel flow channel ports via the internal channel of the second side portion 14 is considered herein. Preferably, the first and second source fuel branch flow channels have substantially the same flow. Optionally, the source fuel flow channel structure may have a substantially constant flow area, and/or the flow area of the source fuel flow channel structure may be smaller than the flow area of any channel formed in the first side portion.

Moreover, although in order to more clearly describe the integrated double-layer flow channel design concept according to the present disclosure, a first layer flow channel recessed from the first side surface 12-0 along the first lateral direction is mainly described in conjunction with the first side portion, and a second layer flow channel formed inside the integrated flow channel module is mainly described in conjunction with the second side portion, it is understood that the first layer flow channel and the second layer flow channel are not necessarily arranged in different thickness ranges. On the contrary, the first layer flow channel may also be arranged in a staggered manner with the second layer flow channel to have an intersecting thickness range. This helps further reduce the volume, weight and manufacturing cost of the integrated flow channel module 10.

Preferably, the integrated flow channel module 10 is integrally cast from a metal such as an aluminum alloy. However, plastics are also considered. Moreover, in addition to being used to form a fuel distribution and recycling loop, the integrated flow channel module 10 may also comprise a flow channel structure related to the safety management of the fuel. For example, as shown in FIGS. 2A-2D, the purge flow channel structure for introducing a working medium into a purge port of the end cover of the stack may also be formed in the integrated flow channel module 10, and the purge flow channel structure may comprise a purge inlet 20-1 (see FIG. 2D) protruding from the second side 14-0 along the first lateral direction at a position adjacent to the second anode outlet lug 12-22, a purge channel 20-2 (see FIG. 2C) that is fluidically connected to the purge inlet 20-1 and extends in the second transverse direction in the second side portion 14 to a length of less than the third distance, and a purge outlet 20-3 (see FIG. 2A) that is fluidically connected to the purge channel 20-2 and extends through the first side surface 12-0 along the second lateral direction.

Although the integrated flow channel module and the anode subsystem for the dual-stack fuel cell system having the integrated flow channel module according to the principles of the present disclosure have been described in combination with the best practices known to the inventors, embodiments based on any other reasonable combination of the features disclosed herein are also considered to fall within the spirit and scope of the present disclosure, as understood by those skilled in the art.

What is claimed is:

1. An integrated flow channel module of an anode subsystem for a dual-stack fuel cell system, comprising:
a first side surface configured to be sealed and connected to an end cover of a stack;
multiple groups of channels recessed from the first side surface along the thickness direction of the integrated flow channel module, the multiple groups of channels being configured to be fluidically connected to a first and second ejector of the anode subsystem and a water separation recycling pump to form a first flow path for recycling the fuel discharged from anode outlets of a first and second stack back to anode inlets of the first and second stacks; and
a group of distribution channels formed inside the integrated flow channel module, the group of distribution channels being configured to fluidically connect a fuel source of the anode subsystem to the first and second ejectors to form a second flow path for distributing the fuel from the fuel source between the first and second ejectors.

2. The integrated flow channel according to claim 1, further comprising:
a first group of interfaces configured to be connected to the anode outlets of the first and second stacks;
a second group of interfaces configured to be connected to the water separation recycling pump;
a third group of interfaces configured to be connected to the first and second ejectors; and
a fourth group of interfaces configured to be connected to the anode inlets of the first and second stacks of the integrated flow channel module,
wherein the first group of interfaces, the second group of interfaces, the third group of interfaces, and the fourth group of interfaces are arranged sequentially along the width direction of the integrated flow channel module.

3. The integrated flow channel module according to claim 2, wherein along the length direction of the integrated flow channel module: the first group of interfaces are arranged in the second group of interfaces between a first and second pump interface respectively configured to be connected to an input port and an output port of the water separation recycling pump, and the third group of interfaces extends from a position roughly flush with the first pump interface to a greater length range than the second group of interfaces.

4. The integrated flow channel module according to claim 3, wherein along the length direction of the integrated flow channel module, in the third group of interfaces, the first and third group of interfaces configured to be connected to the first ejector and the second and the third group of interfaces configured to be connected to the second ejector are arranged separately and/or substantially aligned along the length direction of the integrated flow channel module.

5. The integrated flow channel module according to claim 3, wherein:
the multiple groups of channels comprise a first group of channels fluidically connecting a first group of interfaces to a first pump interface,
a first anode outlet interface in the first group of interfaces is farther from the first pump interface than a second anode outlet interface in the first group of interfaces, and
a first converging branch channel in the first group of channels, which is configured to fluidically connect the first anode outlet interface to the first pump interface, has a section of the channel extending between the first and second anode outlet interfaces along the length direction of the integrated flow channel module.

6. The integrated flow channel module according to claim 3, wherein the multiple groups of channels comprise a second group of channels configured to fluidically connect the water separation recycling pump to the first and second ejectors, wherein the second group of channels comprises a first recycling branch channel fluidically connecting the second pump interface to a first ejection interface in the third group of interfaces, which is configured to be connected to an ejection inlet of the first ejector, and a second recycling branch channel fluidically connecting the second pump interface to a second ejection interface in the third group of interfaces, which is configured to be connected to an ejection inlet of the second ejector, wherein the second pump interface is unequally distant from the first and second ejection interfaces, and wherein the first and second recycling branch channels have different flow channel configurations configured to allow the fluidic flow to have substantially consistent flow and pressure at the first and second ejection interfaces.

7. The integrated flow channel module according to claim 3, wherein the multiple groups of channels comprise a third group of channels configured to fluidically connect the first and second ejectors to the anode inlets of the first and second stacks respectively, wherein the third group of channels comprises a first feed channel that fluidically connects a first mixing outlet interface in the third group of interfaces, which is configured to be connected to a jet-ejection mixing outlet of the first ejector, to a first anode inlet interface in the fourth group of interfaces, which is configured to be connected to the anode inlet of the first stack, and a second feed channel that fluidically connects a second mixing outlet interface in the third group of interfaces, which is configured to be connected to a jet-ejection mixing outlet of the second ejector, to a second anode inlet interface in the fourth group of interfaces, which is configured to be connected to the anode inlet of the second stack, wherein the distance between the first mixing outlet interface and the first anode inlet interface is different from the distance between the second mixing outlet interface and the second anode inlet interface, and wherein the first and second feed channels have different flow channel configurations configured to allow the fluidic flow to have substantially consistent flow and pressure at the first and second anode inlet interfaces.

8. The integrated flow channel module according to claim 3, wherein the group of distribution channels is fluidically connected to a source interface of the integrated flow channel module, which is configured to be connected to a fuel source, and the group of distribution channels comprises a source fuel main branch channel fluidically connected to the source interface, a first source fuel branch channel branching from the source fuel main branch channel and fluidically connected to a first jet interface in the third group of interfaces, which is configured to be connected to the jet inlet of the first ejector, and a second source fuel branch channel branching from the source fuel main branch channel and fluidically connected to a second jet interface in the third group of interfaces, which is configured to be connected to the jet inlet of the second ejector, wherein the first and second source fuel branch channels have substantially the same flow.

9. The integrated flow channel module according to claim 1, wherein the group of distribution channels has a substantially constant flow area, and/or the group of distribution channels has a smaller flow area than the multiple groups of channels, and/or a purge flow channel structure for introducing a working medium into a purge port of an end cover of a stack is also formed in the integrated flow channel module.

10. An anode subsystem for a dual-stack fuel cell system, the dual-stack fuel cell system comprising a first and second stack arranged in a stack and connected in parallel, and the anode subsystem comprising a fuel source, a first ejector, a second ejector, a water separation recycling pump and the integrated flow channel module according to claim 1, wherein the integrated flow channel module is fluidically connected to the fuel source, the first ejector, the second ejector and the water separation recycling pump to form a distribution flow path for providing fuel from the fuel source to anode inlets of the first and second stacks via the first and second ejectors, respectively, and a recycling flow path for recycling the fuel discharged from anode outlets of the first and second stacks back to the anode inlets of the first and second stacks via the first and second ejectors, respectively.
